(19) United States
(12) Patent Application Publication
(10) Pub. No.: US 2025/0078786 A1
(43) Pub. Date: Mar. 6, 2025

(54) PERCUSSION INSTRUMENT AND MUSICAL SOUND GENERATION METHOD

(71) Applicant: Roland Corporation, Shizuoka (JP)

(72) Inventors: Yutaka Morita, Shizuoka (JP); Ryo Takasaki, Shizuoka (JP); Kenji Sakamoto, Shizuoka (JP); Koki Takaishi, Shizuoka (JP)

(73) Assignee: Roland Corporation, Shizuoka (JP)

(21) Appl. No.: 18/773,530

(22) Filed: Jul. 15, 2024

(30) Foreign Application Priority Data
Aug. 31, 2023 (JP) 2023-141757

(51) Int. Cl. G10D 13/10; G10D 13/01

(52) U.S. Cl. CPC G10D 13/25; G10D 13/01; G10D 13/26

(57) ABSTRACT

A light sensor 19 is provided for detecting a position of a lever 14 (an intermediate position between an initial position and a terminal position of the lever 14) between an ON state and an OFF state of the lever 14, and a musical sound in accordance with the position of the lever 14 detected by the light sensor 19 is generated. That is, in each of the ON state of the lever 14, the OFF state of the lever 14, and the state where the lever 14 is therebetween, different musical sounds are generated when the head 6 is percussed. Therefore, compared with the conventional technique where musical sounds can only be generated based on the ON or OFF state of the lever 14, musical sounds of a greater variety can be generated.

### CROSS-REFERENCE TO RELATED APPLICATION

This application claims the priority benefit of Japan application serial no. 2023-141757, filed on Aug. 31, 2023. The entirety of the above-mentioned patent application is hereby incorporated by reference herein and made a part of this specification.

### BACKGROUND

### Technical Field

The disclosure relates to a percussion instrument and a musical sound generation method, and particularly relates to a percussion instrument and a musical sound generation method capable of generating various musical sounds.

### Description of Related Art

For example, Patent Document 1 discloses a percussion instrument able to bring a snare wire 29 into contact with or separate the snare wire 29 from the lower surface of a resonance head 22 through an operation that rotates a lever 34. In such percussion instrument, by using a sensor 48 provided on the lower surface of the resonance head 22, whether the snare wire 29 contacts the resonance head 22 is detected. In the case where a batter head 21 is percussed, different musical sounds are generated when the resonance head 22 and the snare wire 29 are in contact and when the resonance head 22 and the snare wire 29 are separated. Accordingly, various musical sounds can be generated.

### PRIOR ART DOCUMENT(S)

### Patent Document(s)

Patent Document 1 Japanese Laid-open No. 2017-194585 (see, for example, para. 0019, 0022, FIGS. 1, 2).

However, in the conventional technique, it is only possible to generate two types of musical sounds when the resonance head 22 and the snare wire 29 are in contact (the state where the lever 34 is ON) and when the resonance head 22 and the snare wire 29 are separated (the state where the lever 34 is OFF). Therefore, it is still insufficient from the point of generating various musical sounds.

The disclosure provides a percussion instrument and a musical sound generation method capable of generating various musical sounds.

### SUMMARY

In order to achieve the objective, an aspect of the disclosure provides a percussion instrument. The percussion instrument includes: a percussed object, percussed by a player; an operator, rotatable and provided to adjust a musical sound generated at a time when the percussed object is percussed; and a first sensor, detecting a position of the operator between an initial position and a terminal position of a rotation operation of the operator. The percussion instrument is able to generate information for controlling the musical sound in accordance with the position of the operator detected by the first sensor.

Another aspect of the disclosure provides a musical sound generation method. The musical sound generation method is provided for a percussion instrument including: a percussed object, percussed by a player; an operator, rotatable and provided to adjust a musical sound generated at a time when the percussed object is percussed; and a first sensor, detecting a position of the operator between an initial position and a terminal position of a rotation operation of the operator. The musical sound generation method includes: generating the musical sound based on the position of the operator detected by the first sensor.

### BRIEF DESCRIPTION OF THE DRAWINGS

FIG. 1 is an exploded perspective view illustrating a percussion instrument according to an embodiment.

FIG. 2 is a perspective view illustrating a state in which a lever is removed from a bracket.

FIG. 3 is a partially enlarged cross-sectional view illustrating the percussion instrument.

FIG. 4 is a partially enlarged cross-sectional view illustrating the percussion instrument in a state in which the lever is rotated from the state of FIG. 3.

FIG. 5 is a partially enlarged cross-sectional view of the percussion instrument taken along a line V-V of FIG. 3.

FIG. 6 is a block diagram illustrating an electrical configuration of the percussion instrument.

FIG. 7 is a block diagram illustrating a configuration of a detection circuit.

FIG. 8A is a flowchart illustrating an initialization process, and FIG. 8B is a flowchart illustrating a periodic process.

FIG. 9 is a flowchart illustrating a lever position detection process.

FIG. 10 is a flowchart illustrating a musical sound generation process.

### DESCRIPTION OF THE EMBODIMENTS

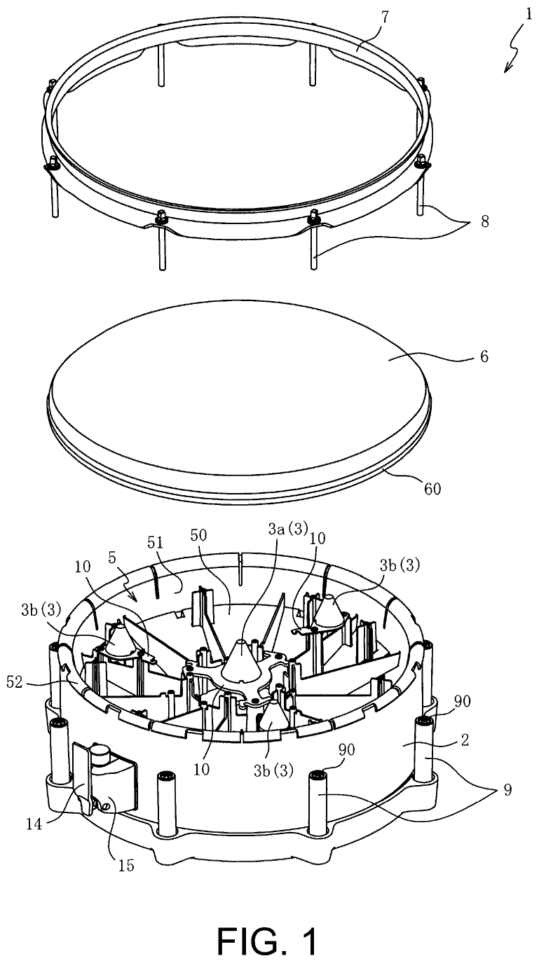

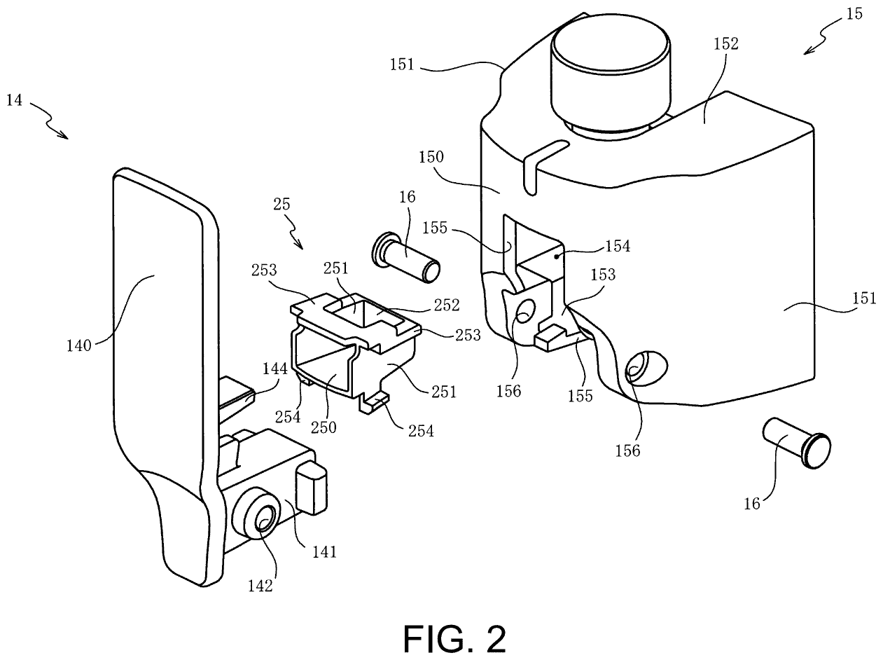

In the following, the exemplary embodiment are described with reference to the drawings. Firstly, referring to FIGS. 1 and 2, the overall configuration of a percussion instrument 1 is described. FIG. 1 is an exploded perspective view illustrating a percussion instrument 1 according to an embodiment. FIG. 2 is a perspective view illustrating a state in which a lever 14 is removed from a bracket 15.

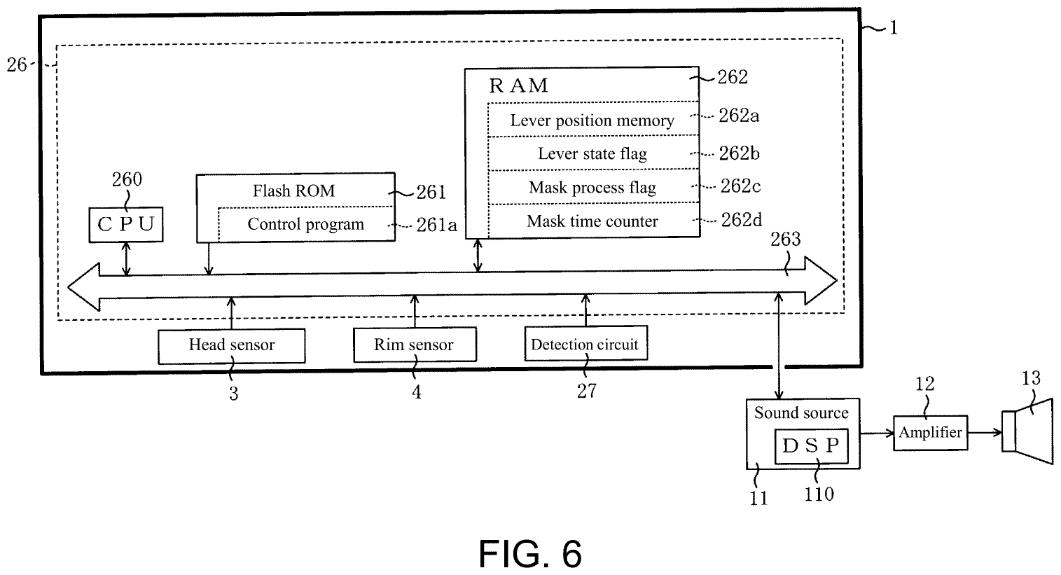

As shown in FIG. 1, the percussion instrument 1 is an electronic percussion instrument simulating an acoustic drum, and includes a shell 2 forming the housing thereof. The shell 2 is formed in a cylindrical shape by using metal, wood, or resin. In the following description, the direction around the axis of the shell 2 is described as a circumferential direction, and the direction orthogonal to the axis of the shell 2 is described as a radial direction. A frame 5 supporting a head sensor 3 and a rim sensor 4 (see FIG. 6 for the rim sensor 4) is hooked to the upper edge portion of the shell 2.

The frame 5 includes a bottom part 50, a sidewall part 51, a curved part 52. The bottom part 50 is in a substantially disc shape. The sidewall part 51 stands upward from the outer edge of the bottom part 50. The curved part 51 is formed on the upper edge of the sidewall part 51. The respective parts 50 to 52 are integrally formed by using a resin material.

The sidewall part 51 of the frame 5 is formed in a cylindrical shape surrounding the entire periphery of the bottom part 50, and the curved part 52 is curved from the upper edge of the sidewall part 51 toward the outer peripheral side. The curved part 52 is formed in an arc shape (convex upward) along the upper edge of the shell 2. With the curved part 52 being hooked to the upper edge of the shell 2, the frame 5 is supported by the inner peripheral side of the shell 2.

An opening portion of the frame 5 (shell 2) on the upper end side is covered by a head 6. The head 6 is formed in a disk shape by using a mesh woven by synthetic fibers, and a head frame 60 in an annular shape is fixed to the outer edge of the head 6. The head frame 60 is formed by using a resin material, and the head 6 and the head frame 60 are integrally formed through die-molding. Nevertheless, the head frame 60 may also be formed by using a material (e.g., metal such as aluminum or iron) other than resin, and the head frame 60 may also be bonded to the head 6 through adhesion etc.

The head 6 is fixed to the percussion instrument 1 (shell 2) by using a rim 7 in an annular shape. In the rim 7, through holes (not shown) for insertion of tension bolts 8 are formed at equal interval in the circumferential direction. On the outer peripheral side of the shell 2 (housing), multiple lugs 9 (at eight positions in the embodiment) for fastening the tension bolts 8 are provided at equal intervals in the circumferential direction.

In the lug 9, a screw hole 90 is formed. In the state in which the head frame 60 of the head 6 is hooked to the rim 7, the tension bolt 8 is fastened to the screw hole 90 of the lug 9, thereby applying a tensile force to the head 6. Accordingly, the upper surface of the head 6 serves as a percussion surface, and the vibration of the percussion to the percussion surface is detected by the head sensor 3.

The head sensor 3 is formed by one central sensor 3a supported by the center of the bottom part 50 of the frame 5 and multiple (three in the embodiment) peripheral sensors 3b arranged at equal interval in the circumferential direction on the outer peripheral side with respect to the central sensor 3a. The respective sensors 3a, 3b are installed to a plate 10 fixed to a bottom part 50 of the frame 5.

A disc-shaped sensor (piezoelectric element that is not shown) is bonded to the upper surface of the plate 10 via a cushion (not shown) to which a double-sided tape is attached to the front and back, and the cushion is bonded to the upper surface of the sensor. The central sensor 3a and the peripheral sensors 3b are formed by the cushions and sensors. The cushions bonded to the upper surfaces of the central sensor 3a and the peripheral sensors 3b are cushion materials in a truncated conical shape formed by using a flexible material, such as sponge, rubber, thermoplastic elastomer, etc., and contact the lower surface of the head 6.

While not shown in the drawings, the rim sensor 4 (see FIG. 6) for detecting the percussion to the rim 7 is bonded to the lower surface of the plate 10 supporting the central sensor 3a. The rim sensor 4 is a disc-shaped piezoelectric element. When vibrations are detected by the head sensor 3 and the rim sensor 4, a musical sound signal is generated by a sound source 11 (see FIG. 6) based on such detection result, and the musical sound signal is output to an amplifier 12 and a speaker 13 (see FIG. 6). Accordingly, an electronic musical sound is emitted from the speaker 13. In the percussion instrument 1, a lever 14 for controlling the tone or the volume of the electronic musical sound is provided. The lever 14 is rotatably installed to the outer peripheral surface of the shell 2 by using the bracket 15.

As shown in FIG. 2, the bracket 15 includes an outer peripheral wall 150 forming the outer peripheral surface thereof, and a pair of sidewalls 151 extend toward the inner peripheral side (the side of the shell 2) from the two ends of the outer peripheral wall 150 in the circumferential direction. The upper ends of the pair of sidewalls 151 are connected in the circumferential direction by an upper wall 152, and the lower ends are connected in the circumferential direction by a lower wall 153. The respective walls 150 to 153 of the bracket 15 are integrally formed by using metal.

A cavity 154 surrounded by the respective walls 150 to 153 is provided inside the bracket 15. An opening 155 connecting the cavity 154 and the outside is formed in the bracket 15. The opening 155 is formed so that the outer peripheral wall 150 and the lower wall 153 of the bracket 15 are cut out continuously. An insertion hole 156 penetrating through the sidewall 151 (outer peripheral wall 150) is formed on the lower end side of the opening 155.

A pair of insertion holes 156 are formed to sandwich the opening 155 and face each other. A cylindrically columnar rotation shaft 16 is inserted into each of the pair of insertion holes 156. The lever 144 is pivotally supported by the rotation shaft 16.

The lever 14 includes an operation part 140 extending in the upper-lower direction and a supported part 141 protruding from the inner peripheral surface of the lower end side of the operation part 140 toward the inner peripheral side. In addition, the lever 14 is formed in a substantially L shape. Shaft holes 142 are formed on the side surfaces of the two sides of the supported part 141 toward the circumferential direction.

At the time of assembling the lever 14 to the bracket 15, the supported part 141 is inserted toward the cavity 154 inside the bracket 15 from the opening 155. In the inserted state, the rotation shaft 16 passing through the insertion hole 156 is fit with the shaft hole 142 of the lever 14. Then, by fixing the rotation shaft 16 fit into the shaft hole 142 to the bracket 15 (insertion hole 156) by using a worm screw not shown herein, the lever 14 is rotatably supported by the bracket 15.

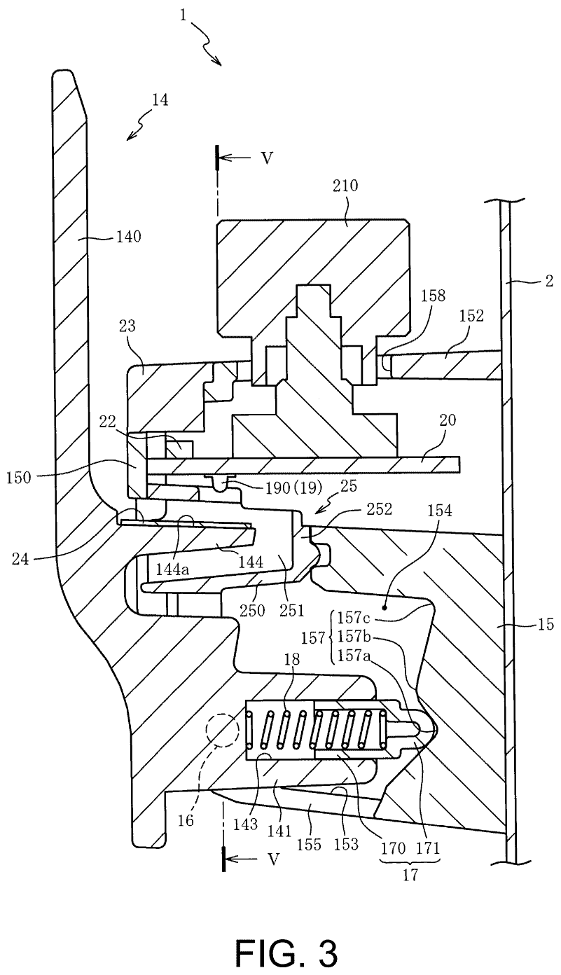

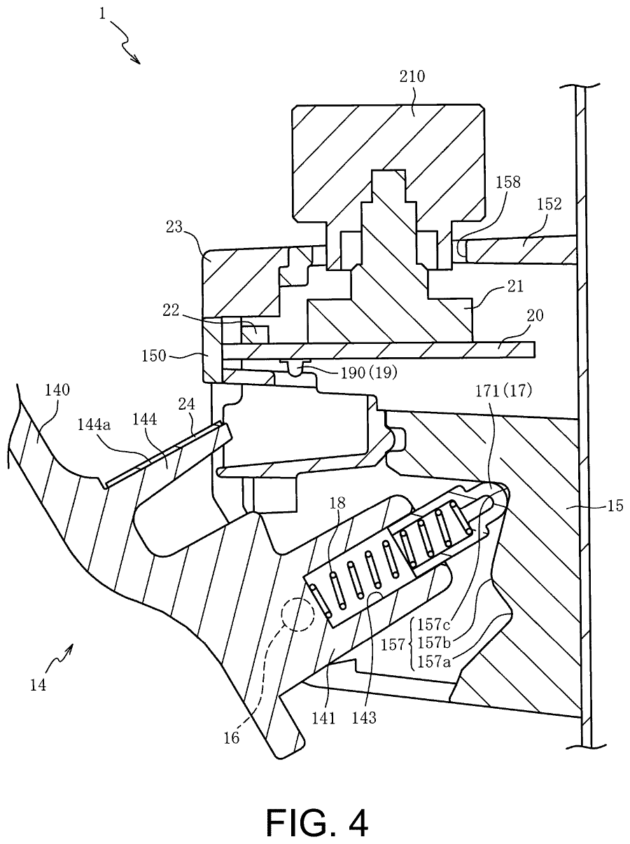

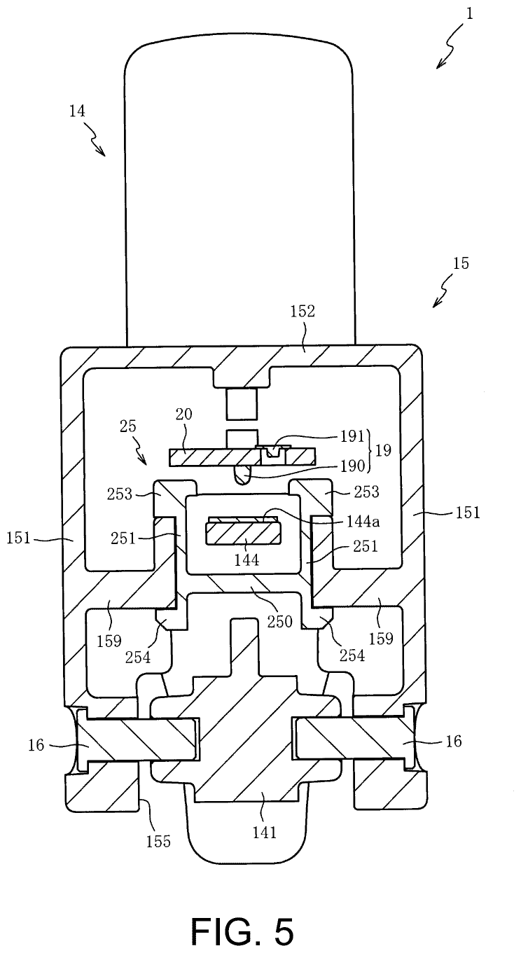

In the following, with reference to FIGS. 2 to 4, the configuration for rotating the lever 14 is described in detail. FIG. 3 is a partially enlarged cross-sectional view illustrating the percussion instrument 1. FIG. 4 is a partially enlarged cross-sectional view illustrating the percussion instrument 1 in a state in which the lever 14 is rotated from the state of FIG. 3. FIGS. 3 and 4 illustrate a cross-section cut at a plane including a light sensor (the optical axis of the light emitted by a light projection element 190), which is a plane orthogonal to the axial direction of the rotation shaft 16. In addition, FIGS. 3 and 4 illustrate the rotation shaft 16 hidden by the lever 14 by using a broken line. In addition, a portion of the internal configuration of the bracket 15 (e.g., a support wall 159 shown in FIG. 5) is omitted to provide schematic illustration.

As shown in FIGS. 2 and 3, in the state in which the lever 14 is pivotally supported by the rotation shaft 16, the supported part 141 of the lever 14 protrudes toward the cavity 154 of the bracket 15 from the rotation shaft 16. In the supported part 141, an insertion hole 143 having an opening is formed at the tip end thereof (the end part on the inner peripheral side). A pin 17 of a plunger is inserted into the insertion hole 143.

The pin 17 includes a cylindrical part 170 having a cylindrical shape and inserted into the insertion hole 143 and a blocking part 171 having a substantially semi-spherical shape and blocking an end side (the right side of FIG. 3) of the cylindrical part 170. The cylindrical part 170 and the blocking part 171 are integrally formed.

A coil spring 18 is inserted into the inner peripheral side of the cylindrical part 170. The coil spring 18 applies an elastic force in a direction protruding from the insertion hole 143 (a direction orthogonal to the axial direction of the rotation shaft 16) to the pin 17. With the elastic force, the blocking part 171 at the tip end portion of the pin 17 is pressed against a sliding wall 157 of the bracket 15. The sliding wall 157 is formed with a first concave surface 157a, a convex surface 157b connected with the upper edge of the first concave surface 157a, and a second concave surface 157c connected with the upper edge of the convex surface 157b.

When viewed in the cross-section cut at the plane orthogonal to the axial direction of the rotation shaft 16, the first concave surface 157a and the second concave surface 157c are formed in a curved shape recessed in a direction away from the rotation shaft 16. In addition, when viewing the same cross-section, the convex surface 157b is formed in a curved shape convex toward the side of the rotation shaft 16. The concave and convex surfaces 157a to 157c are smoothly continuous from the lower end side to the upper end side of the sliding wall 157. In the state in which the blocking part 171 of the pin 17 is pressed against the first concave surface 157a, the operation part 140 of the lever 14 forms a posture extending in the upper-lower direction (vertical direction).

As shown in FIGS. 3 and 4, with the lever 14 being rotated about the rotation shaft 16 so as to push down the operation part 140 from the state in which the blocking part 171 of the pin 17 is pressed against the first concave surface 157a, the blocking part 171 of the pin 17 slides on the convex surface 157b. At this time, the pin 17 slides in a direction that compresses the coil spring 18 inside the insertion hole 143 of the supported part 141. Therefore, it is possible to feel a response when pushing down the lever 14.

When the lever 14 is rotated until the blocking part 171 gets over the top of the convex surface 157b, the pin 17 stretches from the insertion hole 143 due to the elastic force of the coil spring 18, and the blocking part 171 is pressed against the second concave surface 157c. In the state in which the blocking part 171 is pressed against the second concave surface 157c, the operation part 140 of the lever 14 forms a posture inclined with respect to the vertical direction. In the case of being rotated about the rotation shaft 16 to raise the inclined lever 14, through an operation opposite to the case of pushing down the lever 14, the blocking part 171 slides along the sliding wall 157 to be pressed against the first concave surface 157a.

In this way, the lever 14 is configured to be rotatable between the position of raising the operation part 140 (the state of FIG. 3) and the position of pushing down the operation part 140 (the state of FIG. 4). In the percussion instrument 1 of the embodiment, although a snare wire such as an acoustic snare drum is not installed, an operation at the time when the snare wire is brought into contact with a resonance head (a head installed to the opening portion of the shell on a side opposite to the head 6 shown in FIG. 1) can be simulated through rotation to raise the lever 14 in the state of being pushed down. Meanwhile, by performing an opposite operation, an operation at the time of removing the snare wire from the resonance head can be simulated.

In the following description, the state in which the lever 14 is raised (the state of FIG. 3 in which the blocking part 171 is pressed against the first concave surface 157a) is defined as the state in which the lever 14 is ON, and the state in which the lever 14 is pushed down (the state of FIG. 4 in which the blocking part 171 is pressed against the second concave surface 157c) is defined as the state in which the lever 14 is OFF.

The position of the lever 14 (the rotation angle of the lever 14) within the movable range between ON and OFF is detected by the light sensor 19. A substrate 20 is fixed to the inside of the bracket 15. The light sensor 19 is installed to the lower surface of the substrate 20. The light sensor 19 is formed by the light projection element 190 emitting light downward and a light reception element 191 (see FIG. 5) whose light reception part faces downward to receive the light.

The detected part 144 protrudes toward the inner peripheral side from the inner peripheral surface of the operation part 140, and the upper surface of the detected part 144 is formed as a planar reflective surface 144a. In the state in which the lever 14 is ON (the state of FIG. 3), the light sensor 19 and the reflective surface 144a face each other in the upper-lower direction. In addition, the light emitted from the light projection element 190 of the light sensor 19 is reflected by the reflective surface 144a and received by the light reception element 191 (see FIG. 5).

As shown in FIGS. 3 and 4, when the lever 14 rotates from the ON state to the OFF state, the amount of light reflected from the reflective surface 144a toward the light reception element 191 (light received by the light reception element 191) decreases. Meanwhile, when the lever 14 rotates from the OFF state to the ON state, the amount of light reflected from the reflective surface 144a toward the light reception element 191 increases. The light sensor 19 outputs an output value in accordance with a change of the light amount of light received by the light reception element 191, and the position of the lever 14 is detected from the output value of the light sensor 19. During the performance using the percussion instrument 1, the lever 14 is used to perform various operations. A performance method using the percussion instrument 1 is described.

Firstly, the player operates a switch 21 fixed to the upper surface of the substrate 20 and performs various settings in the percussion instrument 1. The various settings refer to the setting of the output level (volume) of the musical sound signal, the setting of ON/OFF of the effect applied to a musical sound, the drum kit setting (the type of the musical sound generated), etc. An example of the drum kit setting is described in the following.

The switch 21 includes an operation part 210 for the player to push or turn. A through hole 158 for the operation part 210 to pass through penetrates through the upper wall 152 of the bracket 15. By rotating the lever 14 between the ON state and the OFF state in a state in which the operation part 210 is operated and the mode of the percussion instrument 1 is set to a drum kit change mode, the drum kit can be selected.

A light emitter 22, such as an LED, is provided on the outer edge side (left side of FIGS. 3 and 4) of the substrate 20 with respect to the switch 21, the light emitter 22 emits light in a color in accordance with the drum kit selected by the player. In other words, the light emitter 22 emits light in a color in accordance with the position of the lever 14. The light emitter 22 is fixed to the upper surface of the substrate 20, and a lens 23 through which the light of the light emitter 22 transmits to the outside is fixed to a corner part where the outer peripheral wall 150 of the drum kit 15 and the upper wall 152 intersect. By visually recognizing the light of the light emitter 22 emitted from the lens 23, the type of the selected drum kit can be determined.

After the drum kit is selected, the operation part 210 is operated to end the various settings (e.g., the mode of the percussion instrument 1 is set to a performance mode). In such state, in the case where the lever 14 is rotationally operated from the OFF state (the state of FIG. 4) to the ON state (the state of FIG. 3), the sound when the snare wire contacts the resonance head is generated. Meanwhile, in the case where the lever 14 is rotationally operated to the OFF state from the ON state, the sound when the snare wire leaves the resonance head is generated. Of course, the sound simulating a snare wire detachment sound is generated when the head 6 or the rim 7 (see FIG. 1) is not percussed.

In addition, in the embodiment, the velocity of the lever 14 is calculated based on the change of the output value of the light sensor 19 (i.e., the position of the lever 14) over time, and a musical sound in accordance with the velocity is generated. For example, in the case where the lever 14 is operated from the OFF state to the ON state at a relatively high velocity, the contact sound between the resonance head and the snare wire is generated at a relatively high volume. Meanwhile, in the case where the lever 14 is operated from the OFF state to the ON state at a relatively low velocity, such contact sound is generated at a relatively low volume. In this way, by generating the contact/detachment sound of the snare wire when the lever 14 is operated, the acoustic snare drum can be simulated by using the percussion instrument 1.

In addition, in the case where the head 6 or the rim 7 (see FIG. 1) is percussed in the state where the lever 14 is ON, a percussion sound (electronic musical sound) at the time when the snare wire contacts the resonance head is generated. Meanwhile, in the case where the head 6 is percussed in the state where the lever 14 is OFF, a percussion sound when the snare wire leaves the resonance head is generated.

Moreover, in the embodiment, in the case where the head 6 is percussed at the time when the lever 14 is located between the ON state and the OFF state, a musical sound of a further different tone is generated. Examples of the musical sound of a further different tone include a musical sound in which an effect (sound effect), such as reverb, delay, vibrato, etc., is applied with respect to the musical sound generated at the time of the percussion to the head 6, a musical sound whose tone or volume different from the musical sound generated at the time of the percussion to the head 6, etc. In addition, musical sounds to which different effects are applied are generated in the case where the head 6 is percussed while the lever 14 is operated at a relatively high velocity and the case where the head is percussed while the lever 14 is operated at a relatively low velocity.

As described above, in the embodiment, the light sensor 19 that detects the position of the lever 14 (an intermediate position between the initial position and the terminal position of the lever 14) between the ON state and the OFF state of the lever 14 is provided, and a musical sound in accordance with the position of the lever 14 detected by such light sensor 19 is generated. That is, in each of the ON state of the lever 14, the OFF state of the lever 14, and the state where the lever 14 is therebetween, different musical sounds are generated when the head 6 is percussed. Therefore, compared with the conventional technique where musical sounds can only be generated based on the states where the lever 14 is ON and OFF, musical sounds of a greater variety can be generated. In addition, since the velocity of the lever 14 can also be detected from the change of the position of the lever 14 over time, different musical sounds are generated in accordance with the velocity. Thus, it is possible to generate a greater variety of musical sounds.

Here, while the position of the lever 14 can be detected by using a magnetic sensor, in the case of such configuration, other metal components (magnetic bodies) in the surroundings may interfere with the magnetism of the magnetic sensor.

Comparatively, in the embodiment, by using the light sensor 19 including the light projection element 190 emitting light toward the reflective surface 144a of the lever 14 and the light reception element 191 receiving the light reflected from the reflective surface 144a, the position of the lever 14 is detected. According to such configuration, differing from the case of using a magnetic sensor, other metal components (magnetic bodies) in the surroundings can be suppressed from affecting the position detection of the lever 14 using the light sensor 19. Accordingly, the position of the lever 14 can be accurately detected.

As another method for detecting the position of the lever 14 by using the light sensor 19, it is possible to adopt a configuration in which the reflective surface of the lever 14 is displaced in the direction of the optical axis of the light sensor 19 (light projection element 190). As such configuration, examples include a configuration in which the tip end surface (the surface facing the right side in FIG. 3) of the detected part 144 is set as a reflective surface, and the light sensor 19 is disposed in a posture where light is emitted in a direction (the left side of FIG. 3) substantially orthogonal to the reflective surface. In the case of such configuration, it suffices as long as the width dimension of the reflective surface in the upper-lower direction (the thickness of the detected part 144) is large enough to be able to reflect the light from the light sensor 19.

However, if the reflective surface of the lever 14 is configured to be displaced in the direction of the optical axis of the light sensor 19, when the detected part 144 (reflective surface) is rotated in a direction away from the light sensor 19, the output value of the light sensor 19 may decrease drastically. Accordingly, the detectable range of the position of the lever 14 may be reduced easily.

Comparatively, in the embodiment, in the state where the lever 14 is ON (the state of FIG. 3), the reflective surface 144a of the detected part 144 is orthogonal to the optical axis of the light sensor 19, and, in the case where the lever 14 is rotated toward the OFF state from such state, the reflective surface 144a is displaced (rotated) in a direction substantially orthogonal to the direction of the optical axis of the light sensor 19 (the light projection element 190). By displacing the reflective surface 144a in this way, in the case where the lever 14 is rotated from ON to the OFF state, the area of the reflective surface 144a reflecting the light of the light sensor 19 (referred to as “reflective region of the reflective surface 144a” in the following) gradually decreases. In the case where the lever 14 is rotated in an opposite direction, the reflective region of the reflective surface 144a can increase gradually.

In this way, by increasing/decreasing the reflective region of the reflective surface 144a together with the rotation of the lever 14, compared with the case where the reflective surface is displaced in the direction of the optical axis of the light sensor 19 as described above, the output value of the light sensor 19 hardly increases/decreases drastically. Accordingly, the detection range of the position of the lever 14 is widened, and the position of the lever 14 can be accurately detected.

In addition, in the embodiment, the axis of the rotation shaft 16 (the rotation center of the lever 14) is orthogonal to the optical axis of the light sensor 19 (the rotation shaft 16 is located on an extension line of the optical axis of the light sensor 19). Accordingly, compared with the configuration in which the axis of the rotation shaft 16 and the optical axis of the light sensor 19 are not orthogonal to each other (e.g., the optical sensor 19 is disposed on the left side with respect to the position shown in FIG. 3), the position of the lever 14 and the reflective region of the reflective surface 144a (the output value of the light sensor 19) may easily increase/decrease proportionally. Accordingly, the position of the lever 14 can be further accurately detected.

In addition, a reflective material 24 is installed to the reflective surface 144a of the detected part 144. While not shown in the drawings, the reflective material 24 is formed by a resin layer formed by using a film made of resin (e.g., PET) and a metal layer manufactured by using metal (e.g., aluminum) laminated on the resin layer. The metal layer is formed by laminating a metal foil on the resin layer or coating metal on the resin layer by using vapor evaporation, etc. The metal layer is laminated between the reflective surface 144a and the resin layer and the upper surface of the metal layer is covered by the resin layer. Therefore, the metal layer can be suppressed from being damaged.

By installing the reflective material 24 to the reflective surface 144a, the amount of light reflected from the reflective surface 144a (reflective material 24) toward the light reception element 191 can be adjusted. Accordingly, the light reception element 191 can receive an appropriate light amount of light. Therefore, the increase/decrease of the reflective region of the reflective surface 144a together with the rotation of the lever 14 can be accurately detected by the light reception element 191. Accordingly, the position of the lever 14 can be accurately detected.

In this way, in the embodiment, the position of the lever 14 is detected based on the light amount of light received by the light reception element 191 of the light sensor 19. Therefore, when the light reception element 191 receives ambient light, the position of the lever 14 cannot be accurately detected. As such ambient light, examples include light that is turned on in pulses (blinking rapidly) at a predetermined frequency, such as LED lighting, and light that is emitted continuously without blinking, such as sunlight and light bulbs.

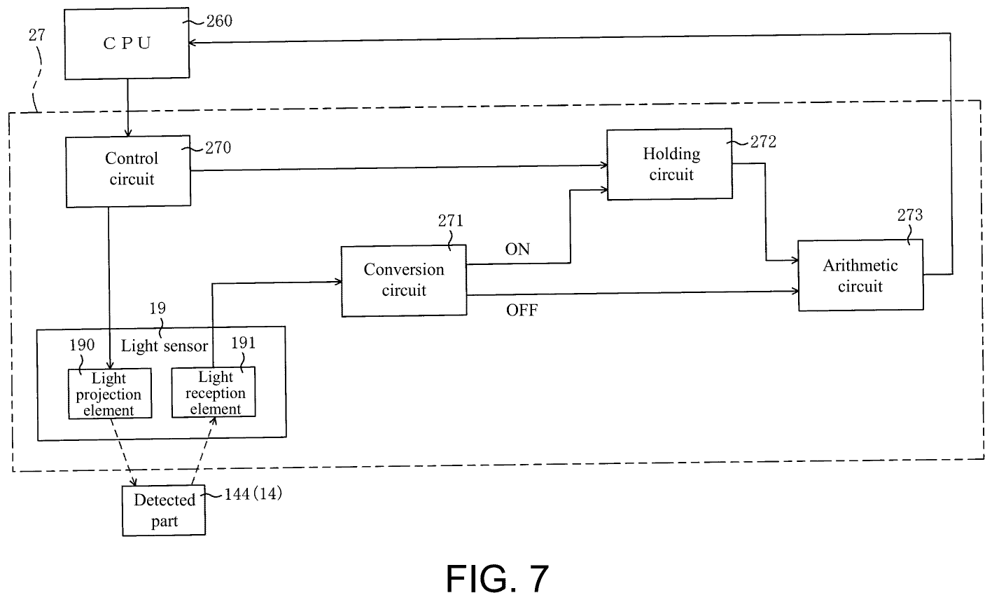

Comparatively, in the embodiment, while details will be described subsequently, it is configured that the light projection element 190 of the light sensor 19 blinks at a high speed (e.g., being turned on at an interval of 0.4 milliseconds) by using a detection circuit 27 (see FIG. 7). Accordingly, whether the light received by the light reception element 191 is the light of the light projection element 190 or the ambient light that emits light continuously, such as sunlight, can be distinguished.

Meanwhile, although the ambient light, such as LED lighting, blinks at a high speed, like the light projection element 190, the LED lighting emits light in a wavelength region of visible light. Comparatively, the light projection element 190 of the embodiment adopts an element that emits light at a wavelength out of the visible light region (near infrared light). Accordingly, whether the light received by the light reception element 191 is the light of the light projection element 190 or the ambient light such as LED lighting can be distinguished.

In this way, with the light projection element 190 blinking at a high speed or emitting light at a wavelength outside the visible light region, the ambient light and the light of the light projection element 190 can be distinguished. Nevertheless, to detect the position of the lever 14 with higher accuracy, it may be that the light reception element 191 is not irradiated with ambient light as much as possible. Regarding a light shielding member 25 for shielding the ambient light, while the description is made mainly with reference to FIGS. 3 and 5, FIG. 2 may also be taken into consideration as appropriate while the description is made. FIG. 5 is a partially enlarged cross-sectional view of the percussion instrument 1 taken along a line V-V of FIG. 3.

As shown in FIGS. 3 and 5, in the light reception element 191 (see FIG. 5) of the light sensor 19, the light reception part thereof faces toward the lower surface side of the substrate 20. Accordingly, the light from lighting, etc., provided on the ceiling side is shielded by the substrate 20 or the upper wall 152 of the bracket 15. Therefore, such ambient light can be suppressed from being erroneously detected by the light reception element 191.

Meanwhile, the opening 155 for insertion of the supported part 141 of the lever 14 is formed on the side of the lower wall 153 (see FIG. 3) of the bracket 15, and the lever 14 is pivotally supported by the rotation shaft 16 provided at the opening 155. A spacing is defined between the supported part 141 and the opening 155 in the periphery of the rotation shaft 16 (the movable portion of the lever 14). Therefore, light reflected from the floor etc., may enter through the spacing. The ambient light from the floor side is shielded by the light shielding member 25.

The light shielding member 25 includes a lower wall part 250 for covering the detected part 144 of the lever 14 from the lower side, and sidewall parts 251 stand upward from the two ends of the lower wall part 250 in the circumferential direction. An inner wall part 252 stands upward from the end of the lower wall part 250 on the inner peripheral side (the right side of FIG. 3), and the inner wall part 252 connects the pair of sidewall parts 251.

A pair of overhanging parts 253 (see FIG. 5) overhang on the two sides in the circumferential direction from the side surfaces of the pair of sidewall parts 251 on the upper end side, and a claw part 254 in a substantially L shape (see FIG. 2 for the point that the claw part 254 is formed in an L shape) is formed at the lower end of each of the pair of sidewall parts 251. The respective wall parts 250 to 254 of the light shielding member 25 are integrally formed by using an elastic body, such as rubber or elastomer. The light shielding member 25 is installed to the support wall 159 (see FIG. 5) of the bracket by using the overhang parts 253 and the claw parts 254.

The support wall 159 is an L-shaped wall protruding from the inner surface of the sidewall 151 of the bracket 15. The support wall 159 is formed on each of the pair of sidewalls 151. By hooking the overhang parts 253 and the claw parts 254 of the light shielding member 25 to the pair of support walls 159, the light shielding member 25 is installed to the inside of the bracket 15.

As shown in FIG. 3, when viewed in the axial direction of the rotation shaft 16, the lower wall part 250 of the light shielding member 25 is disposed between the light sensor 19 and the rotation shaft 16. As shown in FIG. 5, in the state in which the lever 14 is ON (the state in which the light of the light sensor 19 is emitted onto the reflective surface 144a), the reflective surface 144a of the lever 14 is located between the light sensor 19 (the light reception element 191) and the light shielding member 25 (the lower wall part 250). Accordingly, even in the case where the spacing between the supported part 141 of the lever 14 and the opening 155 of the bracket 15 is formed on the periphery of the rotation shaft 16, the ambient light that enters from the spacing can be shielded by the lower wall part 250 of the light shielding member 25. Accordingly, the light reception element 191 can be suppressed from receiving the ambient light, so the position of the lever 14 can be accurately detected.

In addition, in the state where the lever 14 is ON, the sidewall parts 251 and the inner wall part 252 (see FIG. 3) of the light shielding member 25 protrude upward (the side of the light sensor 19) from the reflective surface 144a, and the reflective surface 144a is surrounded by the respective wall parts 251, 252. Accordingly, even if the ambient light enters the inside of the bracket 15, the ambient light emitted to the reflective surface 144a can be shielded by the respective wall parts 251, 252. Accordingly, the light reception element 191 can be suppressed from receiving the ambient light, so the position of the lever 14 can be accurately detected.

In this way, the ambient light emitted from the lower side of the bracket 15 can be substantially shielded by the light shielding member 25. In addition, the ambient light from the upper side of the bracket 15 is also substantially shielded by the substrate 20 or the upper wall 152 of the bracket 15. Meanwhile, it is difficult to completely shield the ambient light traveling to the light reception element 191, such as the external light reflected off the lever 14 and entering the bracket 15 or the external light directly entering the bracket 15 (e.g., through the opening 155), etc.

Comparatively, the embodiment is configured to be able to suppress the position of the lever 14 from being erroneously detected due to the ambient light received by the light reception element 191. Regarding the configuration, description is made with reference to FIGS. 6 and 7. FIG. 6 is a block diagram illustrating an electrical configuration of the percussion instrument 1. FIG. 7 is a block diagram illustrating a configuration of the detection circuit 27.

As shown in FIG. 6, the percussion instrument 1 includes a control device 26 for controlling the respective parts of the percussion instrument 1. The control device 26 has a CPU 260, a flash ROM 261, a RAM 262, which are connected via a bus line 263. The CPU 260 is an arithmetic device controlling the respective parts connected by the bus line 263. The head sensor 3, the rim sensor 4, the detection circuit 27, and the sound source 11 are respectively connected to the bus line 263. The detection circuit 27 is a circuit for detecting the position of the lever 14 (see FIGS. 3 and 4). The sound source 11 may also be connected with the percussion instrument 1 wirelessly.

As shown in FIG. 7, the detection circuit 27 includes a control circuit 270 controlling light emission of the light projection element 190 of the light sensor 19. As described above, the light emitted from the light projection element 190 is reflected by the detected part 144 (the reflective surface 144a) of the lever 14 to be received by the light reception element 191. The light sensor 19 outputs the output value in accordance with the light amount of the light received by the light reception element 191 to a conversion circuit 271.

The control circuit 270 causes the light projection element 190 of the light sensor 19 to blink at a predetermined interval (e.g., being turned on at an interval of 0.4 milliseconds), and, in the case where the light of the light projection element 190 is turned off, connects the conversion circuit 271 to a holding circuit 272. When the light projection element 190 is turned off, the conversion circuit 271 converts the current value (output value) output from the light reception element 191 into a voltage value, and outputs the voltage value to the holding circuit 272. The output value output by the light reception element 191 during the time when the light projection element 190 is turned off (referred to as “output value during the time when the light is turned off”) is a value indicating the light amount of ambient light.

Meanwhile, the control circuit 270 cuts off the connection between the conversion circuit 271 and the holding circuit 272 in the case where the light projection element 190 is turned on. The conversion circuit 271 converts the current value (output value) output from the light reception element 191 during the time when the light projection element 190 is turned on, and outputs the voltage value to an arithmetic circuit 273. The output value output by the light reception element 191 when the light projection element 190 is turned on (referred to as “output value during the time when the light is turned on”) is a value indicating the total of the ambient light and the reflected light from the detected part 144.

Then, the arithmetic circuit 273 subtracts the output value during the time when the light is turned off as held by the holding circuit 272 from the output value during the time when the light is turned on, and outputs a subtracted corrected value to the CPU 260 as a value indicating the position of the lever 14. Accordingly, the output value corresponding to the increase due to the ambient light can be subtracted from the output value of the light sensor 19. Therefore, the position of the lever 14 can be suppressed from being erroneously detected due to the influence of the ambient light (the position of the lever 14 can be accurately detected).

Here, as described above, at the time when the lever 14 is rotated from the ON state to the OFF state, the detected part 144 (the reflective surface 144a) is gradually exposed to the outside of the bracket 15 (see FIGS. 3 and 4). Therefore, the light amount of the ambient light received by the light reception element 191 may increase more easily at the time of the OFF state than the time when the lever 14 is in the ON state. That is, the light amount of the ambient light changes in accordance with the position of the lever 14.

Comparatively, in the embodiment, the light projection element 190 blinks at a very high speed (being turned on at an interval of 0.4 milliseconds), and, in the case where the light projection element 190 is turned on, the output value of the light projection element 190 at the time of being turned off immediately before being turned on (at the time of being turned off at the previous time) is held in the holding circuit 272. The output value of the light projection element 190 at the time of being turned off immediately before being turned on is substantially consistent with the light amount of the ambient light actually received by the light reception element 191 when the light projection element 190 is turned on. Therefore, by subtracting the output value at the time of being turned off immediately before being turned on from the output value at the time of being turned on, the output value of the light sensor 19 can be corrected accurately (the increase of the output value due to the ambient light can be accurately subtracted). Accordingly, the erroneous detection of the position of the lever 14 due to the influence of the ambient light can be suppressed (the position of the lever 14 can be accurately removed).

In addition, since the control circuit 270 turns on the light projection element 190 for a time (e.g., 0.1 milliseconds) shorter than the time (e.g., 0.3 milliseconds) during which the light projection element 190 is turned off, the power consumption of the light sensor 19 can be reduced, and the service time of the light sensor 19 (the light projection element 190) can be increased.

Referring to FIG. 6 again, the flash ROM 261 of the control device 26 is a rewritable non-volatile storage device storing programs executed by the CPU 260, fixed value data, etc. The flash ROM 261 stores a control program 261a executed by the CPU 260. The RAM 262 is a memory for rewritable storing various work data, flags, etc., when the control program 261a is executed.

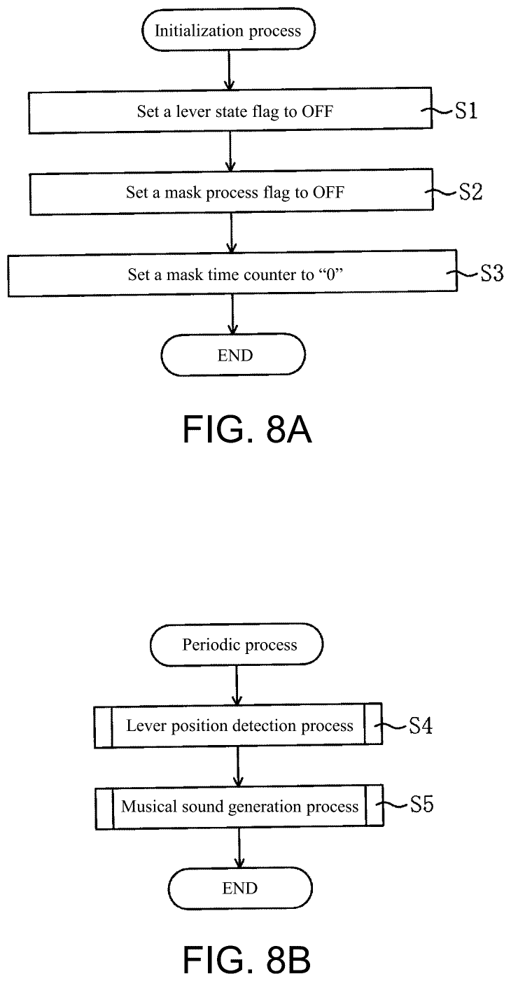

When the control program 261a is executed by the CPU 260, control for generating musical sounds is exerted according to an initialization process and a periodic process (see FIGS. 7, 8A, and 8B) to be described afterwards. Although the processes will be described in detail in the following, the percussion instrument 1 outputs a sound generation instruction from the CPU 260 to the sound source 11 in accordance with the detection results of the head sensor 3, the rim sensor 4, and the detection circuit 27 (information for controlling the musical sound generated by the sound source 11 in accordance with the position of the lever 14 detected by the light sensor 19).

The sound source 11 is a device that controls the tone of the musical sound (percussion sound) or various effects according to the sound generation instruction from the CPU 260. The sound source 11 is built with a DSP 110 performing an arithmetic process such as applying a filter on the waveform data or an effect. The amplifier 12 is connected with the sound source 11, and the speaker 13 is connected with the amplifier 12. The musical sound signal processed by the sound source 11 is amplified by the amplifier 12, and the musical sound is emitted from the speaker 13 based on the amplified musical sound signal.

The RAM 262 is provided with a lever position memory 262a, a lever state flag 262b, a mask process flag 262c, and a mask time counter 262d.

In the lever position memory 262a, the position of the lever 14 detected by the detection circuit 27 (the corrected value of the output value of the light sensor 19) is stored over time. In the lever position memory 262a, the positions of the lever 14 for the previous 5 milliseconds are stored, for example, and the operation velocity of the lever 14 is calculated from the positions of the lever 14 stored over time.

The lever state flag 262b is a flag indicating whether the lever 14 is in the ON state or the OFF state, and the mask process flag 262c is a flag indicating whether a mask process is in progress. The mask process is a process for preventing an erroneous musical sound from being generated due to the vibration when the lever 14 is operated.

More specifically, since the lever 14 is installed to the shell 2 via the bracket 15 (see FIG. 1), the vibration during the time when the lever 14 is operated to the ON state or the OFF state (the terminal position of the movable range), the vibration during the operation of the lever 14 (the time when the lever 14 is rotated in the middle of the movable range) is transmitted to the shell 2. When the vibration transmitted to the shell 2 is detected by the rim sensor 4, there is a concern that a musical sound (referred to “percussion sound of the rim 7”) like the sound when the rim 7 is percussed is generated. That is, the percussion sound of the rim 7 is generated erroneously regardless of whether the lever 14 is operated.

The vibration transmitted to the shell 2 when the lever 14 is operated tends to be smaller than the case when the player percusses the rim 7. Accordingly, in the embodiment, the mask process starts in the case where the lever 14 is operated, and, during a predetermined time when the mask process is executed, among the percussion sounds of the rim 7 generated based on the detection result by using the rim sensor 4, the sound generation of the percussion sound of the rim 7 generated when the output value of the rim sensor 4 is relative small (the volume is relatively small) is canceled. Accordingly, the percussion sound of the rim 7 due to the vibration when the lever 14 is operated can be suppressed from being generated.

Although the mask process ends after a predetermined time has elapsed after the beginning of the mask process, a counter that indicates whether the time of the mask process has elapsed is the mask time counter 262d. The control of musical sound generation, including the mask process, is described with reference to FIGS. 8A to 10.

Firstly, referring to FIGS. 8A and 8B, the initialization process and the periodic process of the percussion instrument 1 are described. FIG. 8A is a flowchart illustrating an initialization process, and FIG. 8B is a flowchart illustrating a periodic process. The initialization process shown in FIG. 8A is executed immediately after the power of the percussion instrument 1 is turned on.

As shown in FIG. 8A, in the initialization process, the lever state flag 262b is set to OFF (S1), and the mask process flag 262c is set to OFF (S2). Then, the mask time counter 262d is set to “0”, and a series of processes are ended.

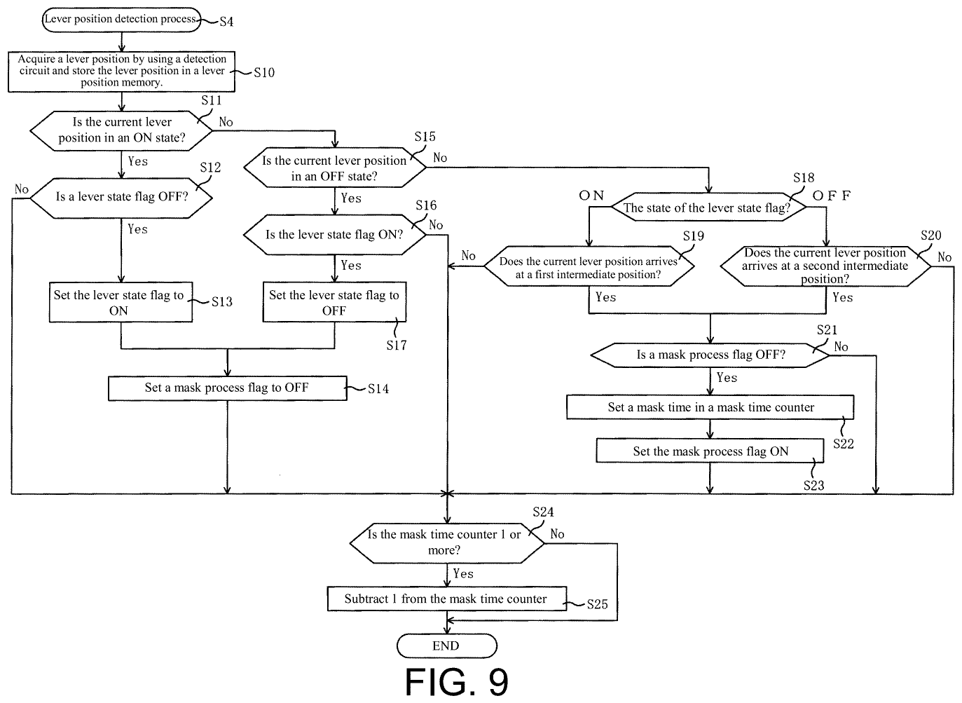

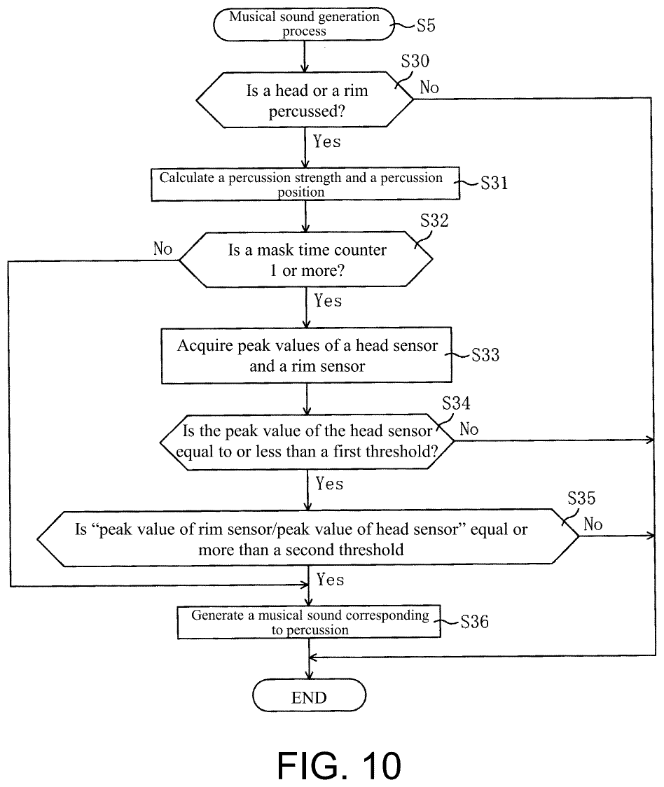

The periodic process shown in FIG. 8B is executed repetitively every 0.1 milliseconds according to an interval interrupt process every 0.1 milliseconds after the initialization process. In the periodic process, a lever position detection process (S4) that detects the position of the lever 14 and a musical sound generation process (S5) that performs the sound generation control based on the detection results of the head sensor 3, the rim sensor 4, and the detection circuit 27 are performed in order. The processes are described with reference to FIGS. 9 and 10. FIG. 9 is a flowchart illustrating the lever position detection process (S4). FIG. 10 is a flowchart illustrating the musical sound generation process (S5).

As shown in FIG. 9, in the lever position detection process of S4, the position of the lever 14 (referred to as “lever position” in the following) is acquired from the detection circuit 27 and stored in the lever position memory 262a (S10). As described above, the operation velocity of the lever 14 can be calculated according to the positions of the lever 14 of the previous 5 milliseconds stored in the lever position memory 262a.

After S10, whether the current lever position acquired in S10 is ON is determined (S11). In the case where the current lever position is ON (S11: Yes), in order to determine whether the lever position is operated from OFF to ON, whether the lever state flag 262b is OFF is determined (S12).

In the case where the lever state flag 262b is OFF (S12: Yes), the lever state flag 262b is set to ON (S13). In the case where the lever state flag 262b is set from OFF to ON, the lever operation is ended, so the mask process flag 262c is set to OFF (S14). Meanwhile, in the process of S12, in the case where the lever state flag 262b is ON (S12: No), the processes of S13, S14 are skipped.

Meanwhile, in the process of S11, in the case where the current lever position is not ON (S11: No), whether the current lever position is OFF is determined (S15). In the case where the current lever position is OFF (S15: Yes), in order to determine whether the lever position is operated from ON to OFF, whether the lever state flag 262b is ON is determined (S16).

In the case where the lever state flag 262b is ON (S16: Yes), the lever state flag 262b is set to OFF (S17). In the case where the lever state flag 262b is set from OFF to ON, the lever operation is ended, so the mask process flag 262c is set to OFF (S14). Meanwhile, in the process of S16, in the case where the lever state flag 262b is OFF (S16: No), the processes of S17, S14 are skipped.

In the case where the current lever position is not ON (S11: No) in the process of S11 and the current lever position is not OFF (S15: No) in the process of S15, the current lever position is between ON and OFF, that is, the lever 14 is in the state of being operated.

Accordingly, in the state where the current lever position is not OFF (S15: No) in the process of S15, whether the lever state flag 262b is ON or OFF is determined (S18). In the case where the lever state flag 262b is ON (S18: ON), the lever 14 is in a state in which an operation from the ON state is started. In this case, whether the current lever position arrives at a first intermediate position is determined (S19). The first intermediate position indicates a value that, in the case where 0 is set when the lever position is OFF and 100 is set when the lever position is ON, the lever position is at 60, for example.

In the case where the lever state flag 262b is OFF (S18: OFF) in the process of S18, the lever 14 is in a state in which an operation from the OFF state is started. In this case, whether the current lever position arrives at a second intermediate position is determined (S19). In the case where the first intermediate position is set at 60, the second intermediate position is set at a position of a smaller value (e.g., 40). That is, the processes of S19, S20 are provided to determine whether the lever 14 is operated to the intermediate region of the movable range thereof (the movable range between the first intermediate position and the second intermediate position).

In the case where the lever 14 is operated to the intermediate region of the movable range, it is necessary to skip music sound generation (start the mask process) so that the percussion sound of the rim 7 is not erroneously generated due to the vibration when the lever 14 arrives at the ON or OFF state.

Accordingly, in the case where the lever position arrives at the first intermediate position (S19: Yes) in the process of S19 or in the case where the lever position arrives at the second intermediate position (S20: Yes) in the process of S20, whether the mask process flag 262c is OFF is determined (S21).

In the case where the mask process flag 262c is OFF (S21: Yes), for example, “800” is set in the mask time counter 262d (i.e., 80 milliseconds are set for the mask time) (S22), and the mask process flag 262c is set to ON. Accordingly, the mask process is started. In the mask process, as described above, regarding the vibration estimated as being generated due to the lever operation, the generation of the musical sound (the percussion sound of the rim 7) based on such vibration is canceled. However, in the case where the head 6 is estimated as being percussed (the vibration detected by the head sensor 3 is relatively large), the generation of the musical sound based on such percussion is not canceled.

In the case where the mask process flag 262c is ON (S21: No) in the process of S21, since the mask process has started, the processes of S22, S23 are skipped. In addition, in the case where the lever position does not arrive at the first intermediate position (S19: No) in the process of S19, or in the case where the lever position does not arrive at the second intermediate position (S20: No) in the process of S20, the lever 14 is in a state of not arriving at the intermediate region of the movable range. Accordingly, in such case, it is not necessary to start the mask process, and the processes of S21 to S23 are therefore skipped.

In addition, after the processes of S12, S14, S16, S19, S20, S21, S23, whether the mask time counter 262d is 1 or more is determined (S24). In the case where the mask time counter 262d is 1 or more (S24: Yes), the mask time counter 262d is subtracted by 1 (S25), and a series of processes are ended. In addition, in the process of S24, in the case where the mask time counter 262d is not 1 or more (S24: No), the mask process is ended, so the process of S25 is skipped and a series of processes are ended. After the lever position detection process of S4, the musical sound generation process (S5) of FIG. 10 is executed.

As shown in FIG. 10, in the musical sound generation process of S5, whether the head 6 or the rim 7 (see FIG. 1) is percussed is determined (S30) based on the output value output from the head sensor 3 (the rim sensor 4). In the case where a predetermined output value or higher is detected by the head sensor (the rim sensor 4), that is, in the case where the head 6 or the rim 7 is percussed (S30: Yes), the percussion strength and the percussion position are calculated (S31). Meanwhile, in the case where the head 6 or the rim 7 is not percussed (S30: No), a series of process are ended.

After the percussion strength and the percussion position are calculated in the process of S31, whether the value of the mask time counter 262d is 1 or more is determined (S32). In the case where the value of the time counter 262d is 1 or more (S32: Yes), while the mask process is in progress, the percussion sound of the rim 7 is generated by using the processes (mask process cancellation unit) of S33 to S35 as follows.

Specifically, in the case where the value of the time counter 262d is 1 or more (S32: Yes), the peak values of the output values of the head sensor 3 and the rim sensor 4 are acquired (S33), and whether the peak value of the head sensor 3 is equal to or less than a first threshold is determined (S34).

In the case where the peak value of the head sensor 3 is equal to or less than the first threshold (S34: Yes), whether “the peak value of the rim sensor 4/the peak value of the head sensor 3” is equal to more than a second threshold is determined (S35). In the case where the peak value of the head sensor 3 is relatively small (S34: Yes) and “the peak value of the rim sensor 4/the peak value of the head sensor 3” is relatively large (S35: Yes), that is, in the case where the vibration detected by the rim sensor 4 is relatively large, the chance that the rim 7 is percussed is high.

Accordingly, in the case where “the peak value of the rim sensor 4/the peak value of the head sensor 3” is equal to or more than the second threshold, a musical sound according to the percussion to the rim 7 is generated (output the sound generation instruction) (S36), and a series of processes are ended.

Meanwhile, in the case where the peak value of the head sensor 3 exceeds the first threshold (S34: No), or in the case where “the peak value of the rim sensor 4/the peak value of the head sensor 3” is less than the second threshold is determined (S35: No), the chance that the rim 7 is not percussed is high. Accordingly, in such cases, the processes of S35, S36 are skipped, and a series of processes are ended without generating the percussion sound of the rim 7 (output the sound generation instruction).

In addition, in the process of S32, in the case where the value of the mask time counter 262d is 0 (less than 1) (S32: No), the mask process is not in progress. Therefore, a musical sound is generated in accordance with the percussion to the head 6 or the rim 7 (the control information of the musical sound in accordance with the position of the lever 14 is generated, and output to the sound source) (S36), and a series of processes are ended. In this way, in the embodiment, the generation of the percussion sound of the rim 7 due to the vibration of the lever operation is suppressed, and, in the case where it is estimated that the rim 7 is percussed (the vibration of the percussion to the rim 7 is detected by the rim sensor 4), the percussion sound of the rim 7 can be generated through the processes of S33 to S35 even if the mask process is in progress. Accordingly, the musical sound intended by the player can be easily generated.

Although the above embodiments have been explained above, the disclosure is not limited to the above embodiments. It can be easily inferred that various improvements and modifications can be made without departing from the spirit of the disclosure.

In the embodiment, as an example of the percussion instrument, an electronic percussion instrument (electronic drum) simulating the acoustic drum is exemplified. However, the disclosure is not limited thereto. For example, for an acoustic drum provided with a “strainer lever,” timpani, vibraphone, etc., provided with a “pedal,” the musical sound (electronic sound) generated when a “percussion object” is percussed may be changed based on the position of the “strainer lever” or “pedal”. For example, in the case where the “pedal” of a timpani or vibraphone serves as an operator, the head of the timpani or the sound plate of the vibraphone is equivalent to the “percussed object”. That is, the technique of the embodiment can be applied as long as a percussion instrument is provided with a “rotatable operator provided to adjust the musical sound generated when the percussed object is percussed”.

In the embodiment, the case where the position of the lever 14 between the ON state and the OFF state of the lever 14 is detected by using the light sensor 19, and respectively different musical sounds are generated at the initial position (ON state), the terminal position (OFF state), and positions therebetween (positions between ON and OFF, referred to as “intermediate region” in the following) in the movable range of the lever 14. That is, the example where, in the case where the head 6 (the percussed object) is percussed in the state where the lever 14 is in the intermediate region, one type of musical sound different from the states where the lever 14 is in the initial position and the terminal position is generated is described. However, the disclosure is not limited thereto.

For example, it may also be that the intermediate region in the movable range of the lever 14 is divided into multiple regions, and different musical sounds are generated in the respective regions. As an example of such configuration, a configuration as follows is exemplified: the intermediate region in the movable range of the lever 14 is split into two, i.e., a first region near the ON side and a second region near the OFF side, and different musical sounds (musical sounds applied with different effects) are generated when the head 6 is percussed in the state in which the lever 14 is located at the first region and in the state in which the lever 14 is located at the second region. According to such configuration, a greater variety of musical sounds can be generated. In addition, if the intermediate region in the movable range of the lever 14 is split into three or more (if three or more types of musical sounds are generated in the intermediate region), a greater variety of musical sounds can be generated.

In the embodiment, the case where the musical sound changes at the time of the percussion to the head 6 in accordance with the position of the lever 14 is described. However, the disclosure is not limited thereto. For example, it may also be that the musical sound at the time of the percussion to the rim 7 is changed in accordance with the position of the lever 14 (different effects are applied in accordance with the position of the lever 14). For example, it may also be that the position or the velocity of the lever 14 is detected, and other control is exerted in accordance with the detection result. As the other control, examples may include switching of stage lighting, video, etc.

In the embodiment, the light sensor 19 is exemplified as an example of the sensor (first sensor) that detects the position of the lever 14. However, the position of the lever 14 may also be detected by using other conventional sensors (e.g., a sensor, a potentiometer, etc., that detects a magnetic field change or an electrostatic capacity change).

In the embodiment, the configuration in which the reflective surface 144a is rotated (displaced) in a direction substantially orthogonal to the direction of the optical axis of the light sensor 19 (the light projection element 190) is described. However, the reflective surface of the lever 14 may also be displaced in the direction of the optical axis of the light sensor 19. That is, the position of the light sensor 19 can be set as appropriate as long as the configuration is a configuration that can detect the position of the lever 14.

It is noted that “the reflective surface 144a is displaced in a direction substantially orthogonal to the optical axis of the light sensor 19” indicates that the lever 14 is rotated so that the angle of the reflective surface 144a is constantly 20° or less (or 10° or less) with respect to the optical axis of the light sensor 19 in the state in which the light of the light sensor 19 is emitted to the reflective surface 144a (the reflective surface 144a is located on the optical axis of the light sensor 19).

In addition, “the rotation shaft 16 of the lever 14 (the rotation center of the lever 14) and the optical axis of the light sensor 19 are substantially orthogonal to each other” may indicate that the rotation center of the lever 14 is located on the optical axis of the light sensor 19. However, the rotation center of the lever may not be necessarily located on the optical axis of the light sensor 19, as long as the configuration is a configuration in which the lever 14 is rotated so that the angle of the reflective surface 144a is constantly 20° or less (more preferably 10° or less) with respect to the optical axis of the light sensor 19, as described above.

In the embodiment, the case where the reflective material 24 installed to the reflective surface 144a of the lever 14 is formed by a resin layer and a metal layer, the resin layer being formed by using a film made of resin (e.g., PET), and the metal layer being formed by metal (e.g., aluminum) laminated on the resin layer. However, the disclosure is not limited thereto. For example, other conventional films may also be used as the reflective material 24, or the reflective material 24 may be omitted, as long as the light reflected by the reflective surface 144acan be adjusted.

In the embodiment, the case where the position of the lever 14 is detected by causing the light sensor 19 to blink and subtracting the output value during the time when the light is turned off as held by the holding circuit 272 from the output value during the time when the light is turned on by using the detection circuit 27 (the control circuit 270) is described. However, the process for detecting the position of the lever 14 may also be performed on the CPU 260, instead of the detection circuit 27. In addition, it may also be configured that the light sensor 19 is caused to blink continuously, and such subtraction is not performed.

In the embodiment, the case where the light projection element 190 is turned on for a time period shorter than the time during which the light projection element 190 is turned off. However, the disclosure is not limited thereto. For example, the time during which the light projection element 190 is turned off and the time during which the light projection element 190 is turned on may be the same, or the time during which the light projection element 190 is turned on may be longer than the time during which the light projection element 190 is turned off.

In the embodiment, the case where, if the mask process is executed when the lever 14 is operated, and the rim 7 is estimated as being percussed (the vibration of the percussion to the rim 7 is detected by the rim sensor 4), a percussion sound of the rim 7 is generated even if the mask process is in progress is described. However, the disclosure is not limited thereto. For example, it may also be configured that all the musical sound generation based on the head sensor 3 or the rim sensor 4 is canceled when the mask process is in progress, or it may also be configured that the mask process is not performed.

In the embodiment, the configuration in which the percussion instrument 1 outputs the sound generation instruction to the external sound source 11. However, the percussion instrument 1 may also include the sound source 11. In either configuration, the information controlling the musical sound is generated in accordance with the position of the lever 14 detected by the light sensor 19. and, by generating the musical sound signal by using the sound source 11 based on such information, a variety of musical sounds can be generated.

What is claimed is:

1. A percussion instrument, comprising: a percussed object, percussed by a player; an operator, rotatable and provided to adjust a musical sound generated at a time when the percussed object is percussed; and a first sensor, detecting a position of the operator between an initial position and a terminal position of a rotation operation of the operator,
wherein the percussion instrument is able to generate information for controlling the musical sound in accordance with the position of the operator detected by the first sensor.

2. The percussion instrument as claimed in claim 1, wherein the percussion instrument calculates a velocity of the operator based on the position of the operator detected by the first sensor, and generates the information for controlling the musical sound in accordance with the velocity.

3. The percussion instrument as claimed in claim 1, wherein the first sensor is a light sensor and comprises: a light projection element, emitting light toward a reflective surface of the operator; and a light reception element, receiving light reflected from the reflective surface.

4. The percussion instrument as claimed in claim 3, wherein, in a state in which the light of the light projection element is emitted to the reflective surface, the reflective surface is displaced in a direction substantially orthogonal to an optical axis of the light projection element.

5. The percussion instrument as claimed in claim 3, wherein a rotation shaft of the operator and an optical axis of the light projection element are substantially orthogonal to each other.

6. The percussion instrument as claimed in claim 3, comprising: a light shielding member, disposed between the light sensor and a rotation shaft of the operator when viewed in an axial direction of the rotation shaft,
wherein, in a state in which the light of the light projection element is emitted to the reflective surface, the reflective surface is located between the light reception element and the light shielding member.

7. The percussion instrument as claimed in claim 3, wherein the operator comprises a reflective material, installed to the reflective surface and provided for adjusting an amount of light reflected by the reflective surface.

8. The percussion instrument as claimed in claim 3, comprising: a lighting control unit, causing the light projection element to blink; and a storage unit for storing, as an output value at a time during which the light projection element is turned off, an output value of the light reception element at the time during which the light projection element is turned off by the lighting control unit,
wherein the position of the operator is detected based on a value obtained by subtracting the output value at the time during which the light projection element is turned off as stored in the storage unit from an output value of the light reception element at a time during which the light projection clement is turned on by the lighting control unit.

9. The percussion instrument as claimed in claim 8, wherein the lighting control unit turns on the light projection element during a time shorter than the time during which the light projection element is turned off.

10. The percussion instrument as claimed in claim 1, comprising: a housing, to which the percussed object and the operator are installed; and a second sensor, detecting vibration of the housing,
wherein the percussion instrument is able to generate the information for controlling the musical sound in accordance with a detection result of the second sensor, and, in a case where it is estimated that the vibration of the housing due to an operation of the operator is detected by the second sensor, the percussion instrument does not generate the information for controlling the musical sound based on the detection result.

11. The percussion instrument as claimed in claim 10, wherein, in a case where it is estimated that the vibration of the housing due to percussion is detected by the second sensor, the percussion instrument generates the information for controlling the musical sound based on the detection result.

12. A percussion instrument, comprising: a percussed object, percussed by a player; an operator, rotatable and provided to adjust a musical sound generated at a time when the percussed object is percussed; and a first sensor, detecting a position of the operator,
wherein the percussion instrument is able to generate information for controlling the musical sound in accordance with the position of the operator detected by the first sensor.

13. The percussion instrument as claimed in claim 12, wherein the percussion instrument is configured to calculate a velocity of the operator based on the position of the operator detected by the first sensor, and is configured to generate the information for controlling the musical sound in accordance with the velocity.

14. A musical sound generation method, provided for a percussion instrument comprising: a percussed object, percussed by a player; an operator, rotatable and provided to adjust a musical sound generated at a time when the percussed object is percussed; and a first sensor, detecting a position of the operator between an initial position and a terminal position of a rotation operation of the operator, the musical sound generation method comprising:
generating the musical sound based on the position of the operator detected by the first sensor.

15. The method as claimed in claim 14, comprising:
calculating a velocity of the operator based on the position of the operator detected by the first sensor; and
generating the information for controlling the musical sound in accordance with the velocity.

16. The method as claimed in claim 14, comprising:
emitting light toward a reflective surface of the operator; and
receiving light reflected from the reflective surface,
rotating the operator such that the reflective surface of the operator is displacing in a direction substantially orthogonal to an optical axis of the emitted light.

17. The method as claimed in claim 14, wherein the emitting light toward the reflective surface of the operator and the receiving light reflected from the reflective surface comprise:
emitting blink light toward the reflective surface;
storing an output value of the blink light at a turn-off time during the emitting of the blink light as an turn-off output value,
wherein the method further comprising detecting the position of the operator based on a value obtained by subtracting the turn-off output value from an output value of the blink light at a turn-on time during the emitting of the blink light.

18. The method as claimed in claim 17, wherein the turn-on time is shorter than the turn-off time.

19. The method as claimed in claim 14, wherein the percussion instrument further comprising: a housing, to which the percussed object and the operator are installed; and a second sensor, detecting vibration of the housing,
wherein the method further comprising:
estimating whether the vibration of the housing is due to an operation of the operator or is due to percussion is detected by the second sensor;
not generating the information for controlling the musical sound in accordance with a detection result of the second sensor in a case when the vibration of the housing is due to the operation of the operator is detected by the second sensor.

20. The method as claimed in claim 19, wherein, in a case where it is estimated that the vibration of the housing due to percussion is detected by the second sensor, the percussion instrument generates the information for controlling the musical sound based on the detection result.
